(19) United States
(12) Patent Application Publication
(10) Pub. No.: US 2011/0023501 A1
(43) Pub. Date: Feb. 3, 2011

(54) METHODS AND SYSTEMS FOR BULK ULTRA-HIGH PURITY HELIUM SUPPLY AND USAGE

(76) Inventors: Thomas Robert SCHULTE, Grand Island, NY (US); John Joseph BYRNE, Amherst, NY (US); Michael Clinton JOHNSON, Clarence Center, NY (US); Shrikar CHAKRAVARTI, E. Amherst, NY (US); Kwamina BEDU-AMISSAH, Tonawanda, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 12/512,732

(22) Filed: Jul. 30, 2009

(51) Int. Cl. F17C 9/02

(52) U.S. Cl. 62/50.2

(57) ABSTRACT

This invention relates to methods and systems for reliable ultra-high purity (UHP) helium gas supply and maintaining dedicated onsite inventory. Specifically, the invention employs multiple ISO containers whereby vaporized UHP helium in the standby ISO container(s) is used to build-up pressure in the online ISO container. The thermal shields of the ISO containers can be used to decrease heat leaks into the backup ISO container thereby decreasing helium vaporation rate and the amount of gas needed to be withdrawn in order to maintain the maximum allowable working pressure (MAWP) of the vessel. An even lower supply rate is possible by drawing UHP helium gas using an economizer valve but maintaining liquid in the ISO container. This makes it possible to efficiently manage the supply rate, from low flows to higher flow requirements, and to optimize UHP helium draw rate from the storage vessels. A further advantage is that UHP helium gas sent to the customer is of higher purity since it comes directly from a liquid source. The UHP helium gas can be used in semiconductor manufacturing, e.g., as a carrier gas to introduce precursors into deposition chambers during thin film deposition on the wafers.

### FIELD OF THE INVENTION

This invention relates to methods and systems for delivering ultra-high purity (UHP) helium gas to a usage site, e.g., a semiconductor manufacturing facility. The methods and systems are particularly beneficial for supplying ultra-high purity helium gas at a wide range of flows, maintaining additional ultra-high purity helium gas inventory at a customer site, and supplying ultra-high purity helium gas directly to the utilization point.

### BACKGROUND OF THE INVENTION

When large volumes of gases such as oxygen, nitrogen, argon or hydrogen are required by a customer without onsite production capability, the gases are generally delivered in liquid form from the production site to a storage tank near the point of use. For safety reasons, however, liquefied gases cannot be transported over public roads at pressures significantly above atmospheric. The required higher pressure at the use point for most gases is met by transferring the liquefied gas from the transport vehicle into the storage tank using a liquid gas pump to increase its pressure. The liquefied gas is stored in the storage tank at this high pressure and, upon demand from the use point, is vaporized at the high pressure and delivered to the point of use.

Helium is not amendable to such practices. It has a very low heat of vaporization and so heat introduced to the liquid by the action of a liquid pump causes a significant amount of the liquid to be vaporized and thus lost. Even during transfer by pressure differential from a transport vessel to a storage tank, excessive vaporization and losses of helium occur because the density of cold helium gas is not much different from that of liquid helium and so a large amount of the cold helium gas within the tank is displaced and lost; at higher pressures these displacement losses are even higher. Consequently, the common practice is to transport liquid helium in vacuum-insulated ISO containers to a distribution site (transfill), vaporize the liquid and compress the resulting gas into high pressure cylinders and tube trailers. Increasing demand and use of helium, however, is making this mode of supply impractical since these containers (i.e., cylinders and tube trailers) typically hold small volumes.

Increased demand for helium is mainly due to its use in new semiconductor manufacturing processes. As feature geometries on integrated circuits decrease in size, more advanced processes are required to deposit acceptable films, which in turn usually require more helium at a higher purity. A typical 20 cylinder bundle (with total capacity of 150 Nm³) will last only 30 hours for a use rate of 5 Nm³/hr. Similarly, a use rate of 20 Nm³/hr means a tube trailer with a capacity of 2900 Nm³ will last less than 5 days, and an even higher use rate results in more frequent change-outs. Frequent source changes are undesirable because they are labor intensive and increase the potential for contamination with trace amounts of air and moisture during switching. In addition, transfill capacities may become a limiting factor as compression and filling equipment capacity or failure, real estate availability and cost for multiple tube trailer filling bays also become a concern.

Thus under normal operation conditions, the logistics of helium supply for large volume users are exhaustive but manageable. Under abnormal conditions, however, tube trailer helium supply logistics will be especially unpredictable. Abnormal conditions will occur, for example, when there are extended periods of shortage in global helium supply or when the transfill malfunctions. When such disruptions occur, all of the customers served by the transfill must share the limited remaining inventory or are left without helium. It is expected that the tight supply situation in the helium market could persist due to scheduled plant outages, maintenance disruptions and delays caused by equipment setbacks. Construction of new helium plants is not a viable solution as helium is extracted from natural gas fields and dependent on natural gas production. These factors increase the probability of customer run-outs, thereby having a significantly adverse impact on their processing capabilities.

Therefore a need exists for a new and improved methods and systems for delivering ultra-high purity helium gas to usage sites, and assured long-term inventory to large users in very geographically-dispersed regions. Particularly, a need exists for ensuring reliable ultra-high purity helium supply.

### SUMMARY OF THE INVENTION

This invention relates in part to a method for delivering ultra-high purity helium gas to a usage site, said method comprising:

providing at least one primary vessel containing cryogenic ultra-high purity helium fluid, said ultra-high purity helium fluid comprising ultra-high purity helium liquid and gas; said primary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said primary vessel having at least one inlet opening at or near a top portion of the primary vessel through which ultra-high purity helium gas can be fed into the internal vessel compartment; and said primary vessel having at least one outlet opening above a bottom portion of the primary vessel through which said ultra-high purity helium liquid can be dispensed from the internal vessel compartment;

providing at least one secondary vessel containing cryogenic ultra-high purity helium fluid, said ultra-high purity helium fluid comprising ultra-high purity helium liquid and gas; said secondary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said secondary vessel having at least one outlet opening at or near a top portion of the secondary vessel through which ultra-high purity helium gas can be dispensed to the internal vessel compartment of said primary vessel; said secondary vessel being in ultra-high purity helium gas flow communication with said primary vessel; and said secondary vessel having at least one outlet opening above a bottom portion of the secondary vessel through which said ultra-high purity helium liquid can be dispensed from the internal vessel compartment;

optionally delivering ultra-high purity helium gas from said primary vessel and/or said secondary vessel through at least one economizer apparatus to said usage site, said at least one economizer apparatus comprising a backpressure valve for control of flow of ultra-high purity helium gas therethrough to said usage site;

admitting to said primary vessel from said secondary vessel ultra-high purity helium fluid, said ultra-high purity helium fluid comprising ultra-high purity helium gas, said ultra-high purity helium gas being admitted to a pressure in said primary vessel sufficient to discharge ultra-high purity helium liquid from said primary vessel;

conveying said ultra-high purity helium liquid from said primary vessel to at least one vaporization apparatus; said vaporization apparatus having at least one inlet opening through which ultra-high purity helium liquid can be fed into the vaporization apparatus; and said vaporization apparatus having at least one outlet opening through which ultra-high purity helium gas can be dispensed from the vaporization apparatus;

effecting a phase change of said ultra-high purity helium liquid in said vaporization apparatus to form ultra-high purity helium gas; and

delivering said ultra-high purity helium gas from said vaporization apparatus to said usage site.

This invention also relates in part to a system for delivering ultra-high purity helium gas to a usage site, said system comprising:

at least one primary vessel containing cryogenic ultra-high purity helium fluid, said ultra-high purity helium fluid comprising ultra-high purity helium liquid and gas; said primary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said primary vessel having at least one inlet opening at or near a top portion of the primary vessel through which ultra-high purity helium gas can be fed into the internal vessel compartment; and said primary vessel having at least one outlet opening above a bottom portion of the primary vessel through which said ultra-high purity helium liquid can be dispensed from the internal vessel compartment;

at least one secondary vessel containing cryogenic ultra-high purity helium fluid, said ultra-high purity helium fluid comprising ultra-high purity helium liquid and gas; said secondary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said secondary vessel having at least one outlet opening at or near a top portion of the secondary vessel through which ultra-high purity helium gas can be dispensed to the internal vessel compartment of said primary vessel; said secondary vessel being in ultra-high purity helium gas flow communication with said primary vessel; and said secondary vessel having at least one outlet opening above a bottom portion of the secondary vessel through which said ultra-high purity helium liquid can be dispensed from the internal vessel compartment;

an ultra-high purity helium gas feed line extending exteriorly from at least one outlet opening at or near the top portion of the secondary vessel to the at least one inlet opening at or near the top portion of the primary vessel through which ultra-high purity helium gas can be dispensed to the internal vessel compartment of said primary vessel, the ultra-high purity helium gas feed line containing at least one ultra-high purity helium gas flow control valve therein for control of flow of the ultra-high purity helium gas therethrough, and at least one economizer apparatus; said at least one economizer apparatus comprising a backpressure valve for control of flow of ultra-high purity helium gas therethrough to said usage site;

at least one vaporization apparatus; said vaporization apparatus having at least one inlet opening through which ultra-high purity helium liquid can be fed into the vaporization apparatus; and said vaporization apparatus having at least one outlet opening through which ultra-high purity helium gas can be dispensed from the vaporization apparatus;

an ultra-high purity helium liquid discharge line extending exteriorly from at least one outlet opening above the bottom portion of the primary vessel to the at least one inlet opening of the vaporization apparatus through which ultra-high purity helium liquid can be dispensed to the vaporization apparatus, the ultra-high purity helium liquid feed line containing at least one ultra-high purity helium liquid flow control valve therein for control of flow of the ultra-high purity helium liquid therethrough; and

an ultra-high purity helium gas discharge line extending exteriorly from at least one outlet opening of the vaporization apparatus to said usage site, the ultra-high purity helium gas discharge line containing at least one ultra-high purity helium gas flow control valve therein for control of flow of the ultra-high purity helium gas therethrough.

This invention further relates in part to a method for controlling delivery of ultra-high purity helium gas to a usage site, said method comprising:

providing at least one primary vessel containing cryogenic ultra-high purity helium fluid, said ultra-high purity helium fluid comprising ultra-high purity helium liquid and gas; said primary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said primary vessel having at least one inlet opening at or near a top portion of the primary vessel through which ultra-high purity helium gas can be fed into the internal vessel compartment; and said primary vessel having at least one outlet opening above a bottom portion of the primary vessel through which said ultra-high purity helium liquid can be dispensed from the internal vessel compartment;

providing at least one secondary vessel containing cryogenic ultra-high purity helium fluid, said ultra-high purity helium fluid comprising ultra-high purity helium liquid and gas; said secondary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said secondary vessel having at least one outlet opening at or near a top portion of the secondary vessel through which ultra-high purity helium gas can be dispensed to the internal vessel compartment of said primary vessel; said secondary vessel being in ultra-high purity helium gas flow communication with said primary vessel; and said secondary vessel having at least one outlet opening above a bottom portion of the secondary vessel through which said ultra-high purity helium liquid can be dispensed from the internal vessel compartment;

optionally delivering ultra-high purity helium gas from said primary vessel and/or said secondary vessel through at least one economizer apparatus to said usage site, said at least one economizer apparatus comprising a backpressure valve for control of flow of ultra-high purity helium gas therethrough to said usage site;

admitting to said primary vessel from said secondary vessel ultra-high purity helium fluid, said ultra-high purity helium fluid comprising ultra-high purity helium gas, said ultra-high purity helium gas being admitted to a pressure in said primary vessel sufficient to discharge ultra-high purity helium liquid from said primary vessel;

conveying said ultra-high purity helium liquid from said primary vessel to at least one vaporization apparatus; said vaporization apparatus having at least one inlet opening through which ultra-high purity helium liquid can be fed into the vaporization apparatus; and said vaporization apparatus having at least one outlet opening through which ultra-high purity helium gas can be dispensed from the vaporization apparatus;

effecting a phase change of said ultra-high purity helium liquid in said vaporization apparatus to form ultra-high purity helium gas;

delivering said ultra-high purity helium gas from said vaporization apparatus to said usage site; and

utilizing said ultra-high purity helium gas fed into the internal vessel compartment of said primary vessel from secondary vessel, said one or more thermal shield layers, and/or at least one economizer apparatus to control delivery of said ultra-high purity helium gas to said usage site.

This invention provides a number of advantages. This invention describes methods and systems for reliable UHP helium gas supply and maintaining dedicated onsite inventory. Specifically, the invention employs multiple ISO containers whereby vaporized UHP helium in vapor space and/or a helium gas thermal shield layer of the standby ISO container is used to build-up pressure in the online vessel. The thermal shields of the ISO containers help decrease heat leaks, thereby decreasing evaporation rate and the amount of UHP helium that needs to be withdrawn in order to maintain the maximum allowable working pressure (MAWP) of the vessel. An even lower supply rate is possible by drawing evaporated UHP helium gas from vapor space and/or a helium gas thermal shield layer of both the primary and backup ISO containers through the economizer (as described herein) but maintaining liquid in the ISO containers. This makes it possible to efficiently manage the supply rate, from low flows to higher flow requirements, and to optimize UHP helium draw rate from the storage vessels. A further advantage is that UHP helium gas sent to the customer is of higher purity since it comes directly from a liquid source. Gaseous helium from a tube trailer usually requires an expensive purification process if high purity gas is required.

Expensive transfill expansions, large investments in tube trailers, significant distribution and labor costs to support numerous change-outs for customers with high use rates of helium can become prohibitive. The UHP liquid helium delivery method is overall, a more economical option since it allows larger quantities to be transported. Usage of multiple ISO containers also provides added inventory which is especially desirable during periods of shortages. The customer can optionally use high pressure gas tube trailers to backup the liquid ISO container. Tube trailers are less of a safeguard during supply disruptions and make it more likely that a manufacturing facility will have to shut down due to a run-out of helium. This can have a significant adverse impact on the customer's operation. Also, the inherently high purity of helium from a liquid source eliminates the need for an expensive purification system often required when helium is drawn from gaseous storage vessels.

### BRIEF DESCRIPTION OF THE DRAWINGS

FIG. 1 is a schematic representation of a helium supply system in accordance with this invention.

FIG. 2 is a flow diagram depicting operation logic involving vaporized gas supply.

FIG. 3 is a flow diagram depicting UHP helium supply and usage methodologies.

### DETAILED DESCRIPTION OF THE INVENTION

As used herein, ultra-high purity (UHP) means a gas or liquid having less than about 100 parts per billion, preferably less than about 50 parts per billion, and more preferably less than about 10 parts per billion, of molecular impurities, and having less than about 1000 parts per trillion, preferably less than about 500 parts per trillion, and more preferably less than about 10 parts per trillion, of metallic impurities. Most preferably, UHP gases and liquids have less than about 10 parts per billion of molecular impurities and less than about 10 parts per trillion of metallic impurities.

This invention involves a method for ensuring reliable supply of UHP helium gas to customers with use rates of 10 Nm³/hr or more. In an embodiment, the supply method involves direct shipment and maintenance of multiple bulk liquid helium ISO containers at the customer's site.

This invention is concerned with a robust supply system of UHP helium gas to customers with use rates of 10 Nm³/hr or more. In particular, this invention is concerned with ensuring reliable UHP helium gas supply. This invention provides an effective means of switching from low-volume cylinder/tube trailer supply to support growing application of UHP helium gas in semiconductor processing and other industrial applications.

In accordance with this invention, a method of UHP helium gas supply to large users is provided that results in dedicated UHP helium gas inventories for customers, involves directly supplying UHP liquid helium in ISO containers to the customers and maintaining storage volumes at the production site. This invention eliminates the need for helium transfill and tube trailers. The method of this invention is inherently more reliable from a customer's perspective.

As indicated above, this invention relates in part to a method for delivering ultra-high purity helium gas to a usage site, said method comprising:

providing at least one primary vessel containing cryogenic ultra-high purity helium fluid, said ultra-high purity helium fluid comprising ultra-high purity helium liquid and gas; said primary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said primary vessel having at least one inlet opening at or near a top portion of the primary vessel through which ultra-high purity helium gas can be fed into the internal vessel compartment; and said primary vessel having at least one outlet opening above a bottom portion of the primary vessel through which said ultra-high purity helium liquid can be dispensed from the internal vessel compartment;

providing at least one secondary vessel containing cryogenic ultra-high purity helium fluid, said ultra-high purity helium fluid comprising ultra-high purity helium liquid and gas; said secondary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said secondary vessel having at least one outlet opening at or near a top portion of the secondary vessel through which ultra-high purity helium gas can be dispensed to the internal vessel compartment of said primary vessel; said secondary vessel being in ultra-high purity helium gas flow communication with said primary vessel; and said secondary vessel having at least one outlet opening above a bottom portion of the secondary vessel through which said ultra-high purity helium liquid can be dispensed from the internal vessel compartment;

optionally delivering ultra-high purity helium gas from said primary vessel and/or said secondary vessel (e.g., from vapor space and/or a thermal shield layer of said primary vessel and/or said secondary vessel) through at least one economizer apparatus to said usage site, said at least one economizer apparatus comprising a backpressure valve for control of flow of ultra-high purity helium gas therethrough to said usage site;

admitting to said primary vessel from said secondary vessel (e.g., from vapor space and/or a thermal shield layer of said secondary vessel) ultra-high purity helium fluid, said ultra-high purity helium fluid comprising ultra-high purity helium gas, said ultra-high purity helium gas being admitted to a pressure in said primary vessel sufficient to discharge ultra-high purity helium liquid from said primary vessel;

conveying said ultra-high purity helium liquid from said primary vessel to at least one vaporization apparatus; said vaporization apparatus having at least one inlet opening through which ultra-high purity helium liquid can be fed into the vaporization apparatus; and said vaporization apparatus having at least one outlet opening through which ultra-high purity helium gas can be dispensed from the vaporization apparatus;

effecting a phase change of said ultra-high purity helium liquid in said vaporization apparatus to form ultra-high purity helium gas; and

delivering said ultra-high purity helium gas from said vaporization apparatus to said usage site.

The above method further comprises controlling delivery rate of said ultra-high purity helium gas to said usage site utilizing (i) the ultra-high purity helium gas fed into the internal vessel compartment of said primary vessel from secondary vessel, (ii) the one or more thermal shield layers, and/or (iii) the at least one economizer apparatus.

In an embodiment, the method of this invention involves delivering ultra-high purity helium gas from vapor space and/or a helium gas thermal shield layer of the primary vessel and/or the secondary vessel through at least one economizer apparatus to the usage site. In another embodiment, the method of this invention involves admitting to the primary vessel from vapor space and/or a helium gas thermal shield layer of the secondary vessel ultra-high purity helium gas, the ultra-high purity helium gas being admitted to a pressure in the primary vessel sufficient to discharge ultra-high purity helium liquid from the primary vessel.

With regard to controlling the delivery rate, (i) the ultra-high purity helium gas fed into the internal vessel compartment of said primary vessel from secondary vessel (e.g., from vapor space and/or a helium gas thermal shield layer of the secondary vessel) controls delivery rate of said ultra-high purity helium liquid from said at least one primary vessel to said at least one vaporization apparatus and ultra-high purity helium gas from said at least one vaporization apparatus to said usage site, and ultra-high purity helium gas from said at least one primary vessel and said at least one secondary vessel (e.g., from vapor space and/or a helium gas thermal shield layer of both the primary vessel and the secondary vessel) through said at least one economizer apparatus to said usage site; (ii) the one or more thermal shield layers control net evaporation rate of said ultra-high purity helium liquid in said at least one primary vessel and said at least one secondary vessel, said net evaporation rate controls delivery rate of said ultra-high purity helium liquid from said at least one primary vessel to said at least one vaporization apparatus and ultra-high purity helium gas from said at least one vaporization apparatus to said usage site, and controls delivery rate of said ultra-high purity helium gas from said at least one primary vessel and said at least one secondary vessel (e.g., from vapor space and/or a helium gas thermal shield layer of both the primary vessel and the secondary vessel) through said at least one economizer apparatus to said usage site; and (iii) the at least one economizer apparatus controls delivery rate of said ultra-high purity helium gas from said at least one primary vessel and said at least one secondary vessel (e.g., from vapor space and/or a helium gas thermal shield layer of both the primary vessel and the secondary vessel) to said usage site while maintaining ultra-high purity helium liquid in said at least one primary vessel and said at least one secondary vessel.

An ultra-high purity helium gas feed line can extend exteriorly from at least one outlet opening at or near the top portion of the secondary vessel to the at least one inlet opening at or near the top portion of the primary vessel through which ultra-high purity helium gas can be dispensed to the internal vessel compartment of said primary vessel, the ultra-high purity helium gas feed line containing at least one ultra-high purity helium gas flow control valve therein for control of flow of the ultra-high purity helium gas therethrough, and at least one economizer apparatus; said at least one economizer apparatus comprising a backpressure valve for control of flow of ultra-high purity helium gas therethrough to said usage site.

An ultra-high purity helium liquid discharge line can extend exteriorly from at least one outlet opening above the bottom portion of the primary vessel to the at least one inlet opening of the vaporization apparatus through which ultra-high purity helium liquid can be dispensed to the vaporization apparatus, the ultra-high purity helium liquid feed line containing at least one ultra-high purity helium liquid flow control valve therein for control of flow of the ultra-high purity helium liquid therethrough.

An ultra-high purity helium gas discharge line extends exteriorly from at least one outlet opening of the vaporization apparatus to the at least one usage site, the ultra-high purity helium gas discharge line containing at least one ultra-high purity helium gas flow control valve therein for control of flow of the ultra-high purity helium gas therethrough.

The one or more thermal shield layers have an internal compartment to hold a thermal shield fluid, e.g., a liquid or a gas. In an embodiment, the thermal shield layers comprise liquid nitrogen (LN₂) thermal shield layers and helium gas thermal shield layers.

The thermal shield layers can decrease heat leaks into the at least one primary vessel and the at least one secondary vessel, thereby decreasing net evaporation rate of the ultra-high purity helium liquid in the at least one primary vessel and the at least one secondary vessel. By decreasing heat leaks into the at least one primary vessel and the at least one secondary vessel, and thereby decreasing net evaporation rate of the ultra-high purity helium liquid in the at least one primary vessel and the at least one secondary vessel, the thermal shield layers can decrease the amount of ultra-high purity helium gas needed to be withdrawn from the at least one primary vessel and the at least one secondary vessel in order to maintain maximum allowable working pressure of the at least one primary vessel and the at least one secondary vessel. In an embodiment, heat leaks into the at least one secondary vessel can be reduced by drawing vaporized UHP helium gas from the thermal shield layer of the secondary vessel and supplying it to the vapor space of the at least one primary vessel to build pressure in the primary vessel.

The use of multiple ISO containers in accordance with this invention is benefical for several reasons. For example, multiple ISO containers allows supplying of helium at a wide range of flows, maintaining additional inventory at a customer site, and supplying UHP helium gas directly to the utilization site.

At least two ISO containers, e.g., vacuum insulated ISO containers, are used in the UHP helium gas supply method and system of this invention. One ISO container is on-line while the other is on standby. Heat leaks in the standby ISO container vaporize UHP helium (net evaporation rate (NER) gas) thereby increasing the pressure in the vessel. This NER gas from the vapor space and/or helium gas thermal shield layer of the standby ISO container is drawn, optionally warmed through a pressure building vaporizer and charged to the active ISO container to build and maintain operation pressure. UHP liquid helium from the active ISO container is fed to the product vaporizer and sent to the utilization point. Lower helium supply rates can be achieved by using the thermal shields of the ISO containers to minimize heat leaks and therefore the amount of NER generated and has to be withdrawn. Still lower helium supply rates can be attained by using an economizer to bleed off pressure building gas from the vapor space and/or helium gas thermal shield layers of both the primary and backup vessels to be sent to the customer while maintaining liquid helium in the storage vessels.

A bulk liquid ISO container can hold large amounts of UHP liquid or supercritical helium, for example, 1800-11000 gallons of UHP liquid helium. It is advantageous to supply UHP helium in liquid or supercritical form since larger quantities (over five times as many molecules) can be transported as an equal volume of UHP gaseous helium. A larger volume of UHP helium source significantly reduces the frequency of change-outs, associated labor and risk of contamination. Also, implementing the supply method as described herein provides flexibility in UHP helium gas use rate and allows the customer to efficiently manage the inventory for long periods of time.

UHP helium fluid can be drawn directly from the storage vessel as described above. Impurities present in the vessel are much denser than liquid or cryogenic supercritical helium and so are predominantly at the bottom or deposited on the walls of the vessel. UHP helium can be withdrawn at a temperature not greater than the temperature at which the concentration of the impurity in the fluid being withdrawn equals a predetermined limit, e.g., a limit desired or allowable. This eliminates the need for expensive purification equipments usually required when supply is obtained from a gaseous source.

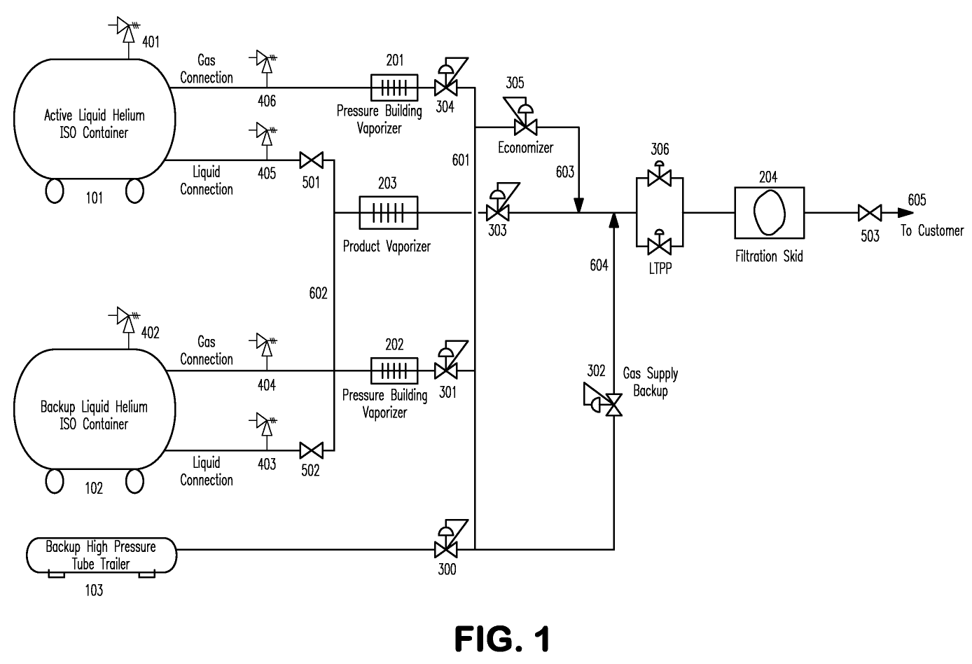

The direct UHP liquid helium supply system consists of several pieces of equipment. This includes UHP liquid helium containers, high-pressure hoses, hose purge assemblies, pressure regulators and product supply pressure relief valves as depicted in FIG. 1. Referring to FIG. 1, vaporized helium (NER gas) from the backup ISO container 102 is optionally warmed through pressure-building vaporizers 202 and 201 and fed to the active ISO container 101 through the gas connection line 601 to build and maintain operating pressure. An optional high pressure tube trailer 103 can also be used for building up pressure in the active ISO container if necessary. Pressure relief valves 401 and 402 are used to maintain allowable pressure in ISO containers 101 and 102 respectively. Pressure relief valves 403, 404, 405 and 406 are used to maintain allowable pressure in the gas connection and liquid connection lines on ISO containers 101 and 102. Control valves 300, 301 and 304 on the gas connection line 601 are used to regulate flow of ISO container pressure building gas or gas that is being directly sent to the economizer 305.

The driving force for fluid flow is pressure difference between the vessel and the utilization point 605. Increased pressure in the primary ISO container 101 is used to drive liquid helium through control valve 501 on the liquid connection line 602 to be vaporized and sent to the point of use. Thus the requisite pressure in the primary supply vessel 101 depends on the desired helium use rate and delivery pressure. Withdrawal is from a port located about 1 to 30 centimeters above the bottom of the vessel. When vessel 101 is online, control valve 502 on the outlet of the liquid delivery line of the standby ISO container 102 is closed and control valve 501 is actuated according to the desired flow rate. Liquid helium driven through line 602 is sent to the product vaporizer 203 to be vaporized and sent to the point of use 605. Flow of the vaporized product is controlled by valves 303 and 503. Vaporized gas also passes through an optional low temperature pressure protection (LTPP) unit 306 (to protect downstream equipment) and then passes through an optional filtration skid 204 (to remove particles).

The rate of helium evaporation in the storage vessel (NER gas) can be controlled with the aid of thermal shields. The thermal shield is a region overlaying the inner vessel compartment that contains liquified helium. Generally, there are several alternating layers of vacuum insulation and thermal shields so that radiant energy that would otherwise pass to the inner vessel of the ISO container is intercepted by the thermal shield fluid. Typically, at least one thermal shield layer is filled with liquified gas such as nitrogen and at least one other thermal shield layer is filled with vaporized UHP helium gas from the inner vessel compartment that contains liquified UHP helium. During transportation of the ISO containers from the production site to the customer's site, which can take up to several weeks, vaporized shield fluid is vented. The liquified gas thermal shield typically holds enough liquified gas to last up to about 30 days.

The heat leaks in the secondary vessel can vaporize the ultra-high purity helium liquid, thereby increasing pressure in said secondary vessel. The evaporated helium gas is conveyed to said primary vessel to build and maintain operating pressure sufficient to discharge ultra-high purity helium liquid from said primary vessel.

Helium fluid can be withdrawn with an impurity concentration sufficiently low for a particular use so long as the temperature at the exit is below the freezing temperature of the impurity. A still lower concentration of impurity may be achieved by withdrawing helium at a temperature not greater than the temperature at which the vapor pressure of the impurity causes the impurity in the fluid withdrawn to reach or equal the concentration limit desired or allowable. Impurities which may be present in helium and the respective approximate temperatures at which the impurity vapor pressure causes the impurity to reach a concentration of 5 parts per million volume (ppmv) in helium fluid at atmospheric pressure include, for example, H₂O (207° K), CO₂ (111° K), O₂ (42° K), Ar (42° K) and N₂ (36° K). For comparison, the respective approximate temperature at which the impurity reaches a concentration of 1 ppmv in helium fluid at atmospheric pressure include, for example, H₂O (197° K), CO₂ (105° K), O₂ (39° K), Ar (39° K) and N₂ (34° K). If several of these impurities are present, helium may be withdrawn from the lower port so long as the withdrawal temperature is not greater than the temperature at which the impurity with the highest vapor pressure reaches the concentration limit in the helium fluid. A more detailed description of withdrawal of cryogenic helium with low impurity from a vessel is described in U.S. Pat. No. 5,386,707, the disclosure of which is incorporated herein by reference.

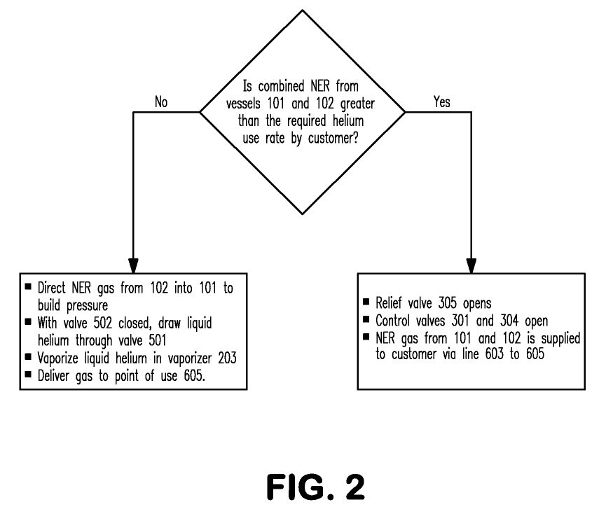

The on-site supply system is also equipped with an economizer apparatus, i.e., backpressure valve, 305 that can be used to bleed off pressure building gas and send directly to the customer. This is essential when gas build-up in the vessels is greater than the customer's draw rate. As the pressure in the vessels increases and reaches the set point on the economizer apparatus, i.e., backpressure valve, 305, gas is forced through line 603 using operation logic as shown in FIG. 2. Valve 305 is set at a lower pressure than the MAWP of the vessels but higher than product valve 303. Higher pressure flow through the economizer keeps valve 303 closed, and supplies product to the customer. In this way, the system can supply helium at very low flow rates (i.e., NER from all the vessels) while maintaining liquid helium in the vessels and under the MAWP. Additionally, UHP helium gas from the thermal shields of the vessels can be drawn and sent to the economizer as described herein. When available, gas can also be directly sent to the customer from the back-up tube trailer through valve 302 and line 604.

Referring to FIGS. 1 and 2, if the combined NER gas from ISO containers 101 and 102 is greater than the required helium use rate by the customer, the economizer apparatus, i.e., backpressure valve, 305 opens, control valves 301 and 304 open, and NER gas from ISO containers 101 and 102 is supplied directly to the usage site 605 via line 603. If the combined NER gas from ISO containers 101 and 102 is not greater than the required helium use rate by the customer, then NER gas is directed from ISO container 102 to ISO container 101 to build pressure, liquid helium is drawn from ISO container 101 through valve 501 to vaporizer 203 where it is vaporized and helium gas is delivered to the usage site 605. The at least one economizer apparatus is controlled to draw ultra-high purity helium gas from the at least one primary vessel and/or the at least one secondary vessel for delivery to the usage site while maintaining ultra-high purity helium liquid in the at least one primary vessel and/or the at least one secondary vessel.

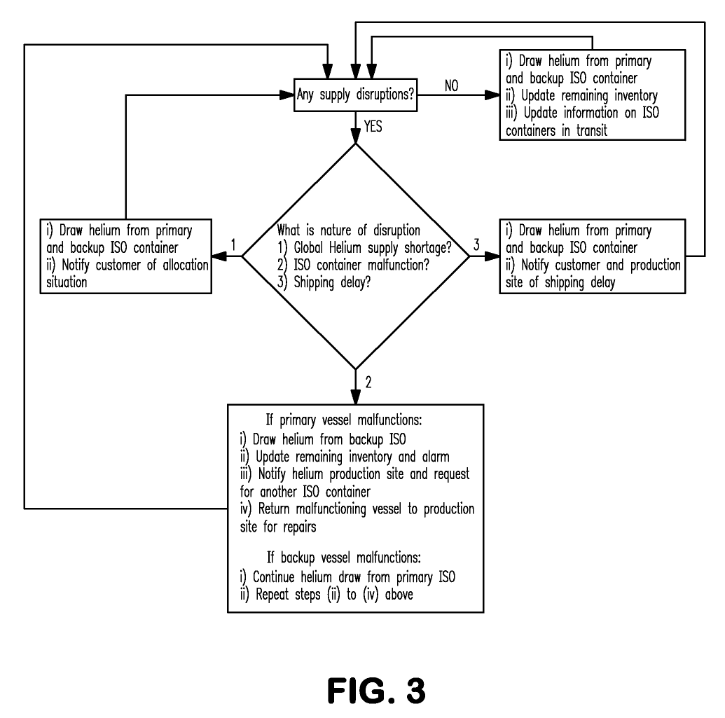

Implementation of the supply process of this invention can involve the use of several ISO containers. The supply process may involve various combinations of primary and secondary containers, for example, one or more primary containers and 2 or more secondary containers, one or more primary containers and 3 or more secondary containers, 2 or more primary containers and 2 or more secondary containers, and the like. The total number of containers required depends primarily on the helium use rate. This is because if the total NER gas from all the containers exceeds the daily requirement, helium has to be vented to atmosphere in order to maintain the MAWP of the ISO containers. Also, the level of inventory the customer wants to maintain onsite and the ISO container transit (shipping) time between the customer and production facility has to taken into account when calculating the total number of containers needed. A schematic of the supply cycle flowchart is shown in FIG. 3. At any point in time, each container is at a different point in the cycle. This includes full and/or partially used containers at the customer's site, empty containers being transported back to the supplier for refilling and containers already refilled and in transit back to the customer site. Under normal operation mode, the new container arrives at the customer site shortly before the active container empties out. A full ISO container is dropped off at a customer site and the empty trailer is taken away to be refilled. If the calculated required number of ISO containers is not a whole number, it is recommended that it is rounded up to the nearest whole number to provide flexibility in the supply system.

The UHP helium gas can be delivered to a variety of usage sites, for example, semiconductor manufacturing sites and other industrial application sites. When the usage site is a semiconductor manufacturing site, ultra-high purity helium gas can be used, for example, as a carrier gas for introducing an organometallic precursor into a chemical vapor or atomic layer deposition chamber. The ultra-high purity helium gas may also be used for dry etching in LCD processes. The ultra-high purity helium gas may further be used in backside cooling to control the rate and uniformity of etching processes of silicon layers. The ultra-high purity helium gas may also be used to check for leaks and line purges.

A remote monitoring system can be used to monitor the mobile liquid storage tanks. It can consist of a telemetry unit that gathers liquid level and head space pressure data and global position data. During shipment, this data is wirelessly transmitted to the customer and/or supplier. If upset conditions of pressure and liquid are reached in the thermal shield and/or ISO container, vapor may be vented in accordance with preset programming in order to attempt to re-establish liquid level and vapor pressure set points. The tracking system also alerts the supplier about shipping delays and other container issues during transport. Once the trailer is at the destination, the customer can elect to continue using the unit to monitor inventory levels or otherwise. Depending on the minimum amount of helium the customer wants to maintain onsite, the customer places an order for a new trailer either on the phone or through an electronic system (e.g., email). The transit time for the ISO container must be taken into account for when this order is placed. This can also be set up automatically such that after a certain period of time, a new trailer is sent out to the customer. See, for example, U.S. Pat. No. 6,922,144, the disclosure of which is incorporated herein by reference.

A control system and methodology can optionally be utilized in the operation of a UHP helium gas delivery system which is configured to enable automatic, real-time optimization and/or adjustment of operating parameters to achieve desired or optimal operating conditions.

A computer implemented system can optionally be used to control NER, supply rates, heating and cooling of the ISO containers, settings on backpressure and relief valves, and the like. The computer control system can have the ability to adjust different parameters in an attempt to optimize delivery of UHP helium gas to the customer site. The system can be implemented to adjust parameters automatically. Control of the UHP helium gas delivery system can be achieved using conventional hardware or software-implemented computer and/or electronic control systems together with a variety of electronic sensors. The control system can be configured to control NER, supply rates, heating and cooling of the ISO containers, settings on backpressure and relief valves, and the like.

The UHP helium gas delivery system can further comprise sensors for measuring a number of parameters such as NER, supply rates, heating and cooling of the ISO containers, backpressure and relief valves, and the like. A control unit can be connected to the sensors and at least one of the inlet openings and outlet openings for conveying UHP helium throughout the system in accordance with the measured parameter values.

The computer implemented system can optionally be part of or coupled with the UHP helium gas delivery system. The system can be configured or programmed to control and adjust operational parameters of the system as well as analyze and calculate values. The computer implemented system can send and receive control signals to set and control operating parameters of the system. The computer implemented system can be remotely located with respect to the UHP helium gas delivery system. It can also be configured to receive data from one or more remote UHP helium gas delivery systems via indirect or direct means, such as through an ethernet connection or wireless connection. The control system can be operated remotely, such as through the Internet.

Part or all of the control of the UHP helium gas delivery system can be accomplished without a computer. Other types of control may be accomplished with physical controls. In an instance, a control system can be a manual system operated by a user. In another example, a user may provide input to a control system as described. A suitable pressure gauge may be used to monitor supply rates (for example, UHP helium gas delivery rates). The air pressure gauge can have a suitable shut-off valve that may be preset to shut off the supply of UHP helium gas to the customer if the rate exceeds a predetermined value.

In the event of abnormal conditions, for example, when there are extended periods of shortage in global helium supply or when the transfill malfunctions, the method of this invention can provide reliable UHP helium supply. Referring to FIG. 3, in the event of a supply disruption, the nature of the disruption is identified, for example, a global helium supply shortage, an ISO container malfunction, or a shipping delay. In the event of a global helium supply shortage, UHP helium can be drawn from the ISO containers on site and the customer notified of the allocation situation. In the event of an ISO container malfunction, UHP helium can be drawn from another ISO container on site and the remaining inventory updated. The helium production site should be notified and another ISO container requested. The malfunctioning ISO container should be returned to the helium production site for repairs. In the event of a shipping delay, UHP helium can be drawn from the ISO containers on site, and the customer and production site notified of the shipping delay. In the event of no supply disruptions, UHP helium can be drawn from the ISO containers on site, the remaining inventory updated, and information of ISO containers in transit updated.

In another embodiment, a large liquid storage volume located at the helium production plant can be maintained for the customer. This storage volume can be in the form of a large volume dewar (e.g., with capacity of 30,000 gallons) connected to the UHP helium liquefier. Once the volume is filled, the UHP helium that vaporizes can be re-liquefied very efficiently. UHP helium in the dewar is pre-sold and dedicated to the specific customer (with details covered by the business agreement). In the event of UHP helium shortage, the dewar will be available to supplement the customer's deliveries. This can be a particularly effective way to manage UHP helium source during plant supply shortfalls (“allocations”) since instances of allocations typically coincide with good availability of shipping containers (i.e., when less-than-maximum amount of product is being shipped, containers free up). Therefore, there is no need to pre-invest in costly shipping containers to be able to ship this product to the customer during allocation periods.

As indicated above, this invention relates in part to a method for controlling delivery of ultra-high purity helium gas to a usage site, said method comprising:

providing at least one primary vessel containing cryogenic ultra-high purity helium fluid, said ultra-high purity helium fluid comprising ultra-high purity helium liquid and gas; said primary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said primary vessel having at least one inlet opening at or near a top portion of the primary vessel through which ultra-high purity helium gas can be fed into the internal vessel compartment; and said primary vessel having at least one outlet opening above a bottom portion of the primary vessel through which said ultra-high purity helium liquid can be dispensed from the internal vessel compartment;

providing at least one secondary vessel containing cryogenic ultra-high purity helium fluid, said ultra-high purity helium fluid comprising ultra-high purity helium liquid and gas; said secondary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said secondary vessel having at least one outlet opening at or near a top portion of the secondary vessel through which ultra-high purity helium gas can be dispensed to the internal vessel compartment of said primary vessel; said secondary vessel being in ultra-high purity helium gas flow communication with said primary vessel; and said secondary vessel having at least one outlet opening above a bottom portion of the secondary vessel through which said ultra-high purity helium liquid can be dispensed from the internal vessel compartment;

optionally delivering ultra-high purity helium gas from said primary vessel and/or said secondary vessel (e.g., from vapor space and/or a thermal shield layer of said primary vessel and/or said secondary vessel) through at least one economizer apparatus to said usage site, said at least one economizer apparatus comprising a backpressure valve for control of flow of ultra-high purity helium gas therethrough to said usage site;

admitting to said primary vessel from said secondary vessel (e.g., from vapor space and/or a thermal shield layer of said secondary vessel) ultra-high purity helium fluid, said ultra-high purity helium fluid comprising ultra-high purity helium gas, said ultra-high purity helium gas being admitted to a pressure in said primary vessel sufficient to discharge ultra-high purity helium liquid from said primary vessel;

conveying said ultra-high purity helium liquid from said primary vessel to at least one vaporization apparatus; said vaporization apparatus having at least one inlet opening through which ultra-high purity helium liquid can be fed into the vaporization apparatus; and said vaporization apparatus having at least one outlet opening through which ultra-high purity helium gas can be dispensed from the vaporization apparatus;

effecting a phase change of said ultra-high purity helium liquid in said vaporization apparatus to form ultra-high purity helium gas;

delivering said ultra-high purity helium gas from said vaporization apparatus to said usage site; and

utilizing said ultra-high purity helium gas fed into the internal vessel compartment of said primary vessel from secondary vessel, said one or more thermal shield layers, and/or at least one economizer apparatus to control delivery of said ultra-high purity helium gas to said usage site.

In an embodiment, the method of this invention involves delivering ultra-high purity helium gas from vapor space and/or a helium gas thermal shield layer of the primary vessel and/or the secondary vessel through at least one economizer apparatus to the usage site. In another embodiment, the method of this invention involves admitting to the primary vessel from vapor space and/or a helium gas thermal shield layer of the secondary vessel ultra-high purity helium gas, the ultra-high purity helium gas being admitted to a pressure in the primary vessel sufficient to discharge ultra-high purity helium liquid from the primary vessel.

With regard to controlling delivery of said ultra-high purity helium gas to said usage site, (i) the ultra-high purity helium gas fed into the internal vessel compartment of said primary vessel from secondary vessel (e.g., from vapor space and/or a helium gas thermal shield layer of the secondary vessel) controls delivery rate of said ultra-high purity helium liquid from said at least one primary vessel to said at least one vaporization apparatus and ultra-high purity helium gas from said at least one vaporization apparatus to said usage site, and ultra-high purity helium gas from said at least one primary vessel and said at least one secondary vessel (e.g., from vapor space and/or a helium gas thermal shield layer of both the primary vessel and the secondary vessel) through said at least one economizer apparatus to said usage site; (ii) the one or more thermal shield layers control net evaporation rate of said ultra-high purity helium liquid in said at least one primary vessel and said at least one secondary vessel, said net evaporation rate controls delivery rate of said ultra-high purity helium liquid from said at least one primary vessel to said at least one vaporization apparatus and ultra-high purity helium gas from said at least one vaporization apparatus to said usage site, and controls delivery rate of said ultra-high purity helium gas from said at least one primary vessel and said at least one secondary vessel (e.g., from vapor space and/or a helium gas thermal shield layer of both the primary vessel and the secondary vessel) through said at least one economizer apparatus to said usage site; and (iii) the at least one economizer apparatus controls delivery rate of said ultra-high purity helium gas from said at least one primary vessel and said at least one secondary vessel (e.g., from vapor space and/or a helium gas thermal shield layer of both the primary vessel and the secondary vessel) to said usage site while maintaining ultra-high purity helium liquid in said at least one primary vessel and said at least one secondary vessel.

As indicated above, this invention relates in part to a system for delivering ultra-high purity helium gas to a usage site, said system comprising:

at least one primary vessel containing cryogenic ultra-high purity helium fluid, said ultra-high purity helium fluid comprising ultra-high purity helium liquid and gas; said primary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said primary vessel having at least one inlet opening at or near a top portion of the primary vessel through which ultra-high purity helium gas can be fed into the internal vessel compartment; and said primary vessel having at least one outlet opening above a bottom portion of the primary vessel through which said ultra-high purity helium liquid can be dispensed from the internal vessel compartment;

at least one secondary vessel containing cryogenic ultra-high purity helium fluid, said ultra-high purity helium fluid comprising ultra-high purity helium liquid and gas; said secondary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said secondary vessel having at least one outlet opening at or near a top portion of the secondary vessel through which ultra-high purity helium gas can be dispensed to the internal vessel compartment of said primary vessel; said secondary vessel being in ultra-high purity helium gas flow communication with said primary vessel; and said secondary vessel having at least one outlet opening above a bottom portion of the secondary vessel through which said ultra-high purity helium liquid can be dispensed from the internal vessel compartment;

an ultra-high purity helium gas feed line extending exteriorly from at least one outlet opening at or near the top portion of the secondary vessel to the at least one inlet opening at or near the top portion of the primary vessel through which ultra-high purity helium gas can be dispensed to the internal vessel compartment of said primary vessel, the ultra-high purity helium gas feed line containing at least one ultra-high purity helium gas flow control valve therein for control of flow of the ultra-high purity helium gas therethrough, and at least one economizer apparatus; said at least one economizer apparatus comprising a backpressure valve for control of flow of ultra-high purity helium gas therethrough to said usage site;

at least one vaporization apparatus; said vaporization apparatus having at least one inlet opening through which ultra-high purity helium liquid can be fed into the vaporization apparatus; and said vaporization apparatus having at least one outlet opening through which ultra-high purity helium gas can be dispensed from the vaporization apparatus;

an ultra-high purity helium liquid discharge line extending exteriorly from at least one outlet opening above the bottom portion of the primary vessel to the at least one inlet opening of the vaporization apparatus through which ultra-high purity helium liquid can be dispensed to the vaporization apparatus, the ultra-high purity helium liquid feed line containing at least one ultra-high purity helium liquid flow control valve therein for control of flow of the ultra-high purity helium liquid therethrough; and

an ultra-high purity helium gas discharge line extending exteriorly from at least one outlet opening of the vaporization apparatus to said usage site, the ultra-high purity helium gas discharge line containing at least one ultra-high purity helium gas flow control valve therein for control of flow of the ultra-high purity helium gas therethrough.

The on-site supply system can be equipped with an economizer apparatus, i.e., backpressure valve, 305 that can be used to bleed off pressure building gas through line 603 and sent directly to the customer using operation logic as shown in FIG. 2. The onsite system can also be equipped with a low temperature pressure protection (LTPP) unit 306 (to protect downstream equipment) and a filtration apparatus 204, e.g., filtration skid, in which the ultra high purity helium gas can pass prior to delivering the ultra-high purity helium gas to the usage site. The filtration skid is used to remove particles.

Although it is recommended that multiple ISO containers be used in the practice of this invention, a small volume user can use a single container with a built-in pressure building coil. This will enable pressure build-up in the vessel without using an outside gas. This method provides significantly higher dedicated onsite levels of inventory than tube trailers. Small volume use customers can also benefit from this invention by using smaller ISO containers with lower NER. Also, although the above disclosure focuses on large electronics customers, this method of supply can be offered to large helium users in other industries.

Various modifications and variations of this invention will be obvious to a worker skilled in the art and it is to be understood that such modifications and variations are to be included within the purview of this application and the spirit and scope of the claims.

1. A method for delivering ultra-high purity helium gas to a usage site, said method comprising:
providing at least one primary vessel containing cryogenic ultra-high purity helium fluid, said ultra-high purity helium fluid comprising ultra-high purity helium liquid and gas; said primary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said primary vessel having at least one inlet opening at or near a top portion of the primary vessel through which ultra-high purity helium gas can be fed into the internal vessel compartment; and said primary vessel having at least one outlet opening above a bottom portion of the primary vessel through which said ultra-high purity helium liquid can be dispensed from the internal vessel compartment;
providing at least one secondary vessel containing cryogenic ultra-high purity helium fluid, said ultra-high purity helium fluid comprising ultra-high purity helium liquid and gas; said secondary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said secondary vessel having at least one outlet opening at or near a top portion of the secondary vessel through which ultra-high purity helium gas can be dispensed to the internal vessel compartment of said primary vessel; said secondary vessel being in ultra-high purity helium gas flow communication with said primary vessel; and said secondary vessel having at least one outlet opening above a bottom portion of the secondary vessel through which said ultra-high purity helium liquid can be dispensed from the internal vessel compartment;
optionally delivering ultra-high purity helium gas from said primary vessel and/or said secondary vessel through at least one economizer apparatus to said usage site, said at least one economizer apparatus comprising a backpressure valve for control of flow of ultra-high purity helium gas therethrough to said usage site;
admitting to said primary vessel from said secondary vessel ultra-high purity helium fluid, said ultra-high purity helium fluid comprising ultra-high purity helium gas, said ultra-high purity helium gas being admitted to a pressure in said primary vessel sufficient to discharge ultra-high purity helium liquid from said primary vessel;
conveying said ultra-high purity helium liquid from said primary vessel to at least one vaporization apparatus; said vaporization apparatus having at least one inlet opening through which ultra-high purity helium liquid can be fed into the vaporization apparatus; and said vaporization apparatus having at least one outlet opening through which ultra-high purity helium gas can be dispensed from the vaporization apparatus;
effecting a phase change of said ultra-high purity helium liquid in said vaporization apparatus to form ultra-high purity helium gas; and
delivering said ultra-high purity helium gas from said vaporization apparatus to said usage site.

2. The method of claim 1 further comprising controlling delivery rate of said ultra-high purity helium gas to said usage site utilizing (i) said ultra-high purity helium gas fed into the internal vessel compartment of said primary vessel from secondary vessel, (ii) said one or more thermal shield layers, and/or (iii) at least one economizer apparatus.

3. The method of claim 1 wherein (i) said ultra-high purity helium gas fed into the internal vessel compartment of said primary vessel from secondary vessel controls delivery rate of said ultra-high purity helium liquid from said at least one primary vessel to said at least one vaporization apparatus and ultra-high purity helium gas from said at least one vaporization apparatus to said usage site and ultra-high purity helium gas from said at least one primary vessel and said at least one secondary vessel through said at least one economizer apparatus to said usage site; (ii) said one or more thermal shield layers control net evaporation rate of said ultra-high purity helium liquid in said at least one primary vessel and said at least one secondary vessel, said net evaporation rate controls delivery rate of said ultra-high purity helium liquid from said at least one primary vessel to said at least one vaporization apparatus and ultra-high purity helium gas from said at least one vaporization apparatus to said usage site, and controls delivery rate of said ultra-high purity helium gas from said at least one primary vessel and said at least one secondary vessel through said at least one economizer apparatus to said usage site; and (iii) said at least one economizer apparatus controls delivery rate of said ultra-high purity helium gas from said at least one primary vessel and said at least one secondary vessel to said usage site while maintaining ultra-high purity helium liquid in said at least one primary vessel and said at least one secondary vessel.

4. The method of claim 1 wherein said one or more thermal shield layers have an internal compartment to hold a thermal shield fluid, said thermal shield fluid comprising a liquid or a gas.

5. The method of claim 1 wherein said one or more thermal shield layers comprise liquid nitrogen (LN₂) thermal shield layers and helium gas thermal shield layers.

6. The method of claim 1 which comprises at least one of (i) delivering ultra-high purity helium gas from vapor space and/or a thermal shield layer of said primary vessel and/or said secondary vessel through at least one economizer apparatus to said usage site, and (ii) admitting to said primary vessel from vapor space and/or a thermal shield layer of said secondary vessel ultra-high purity helium gas, said ultra-high purity helium gas being admitted to a pressure in said primary vessel sufficient to discharge ultra-high purity helium liquid from said primary vessel.

7. The method of claim 1 wherein said thermal shield layers decrease heat leaks into said at least one primary vessel and said at least one secondary vessel, thereby decreasing net evaporation rate of said ultra-high purity helium liquid in said at least one primary vessel and said at least one secondary vessel.

8. The method of claim 1 wherein said thermal shield layers decrease heat leaks into said at least one primary vessel and said at least one secondary vessel, thereby decreasing net evaporation rate of said ultra-high purity helium liquid in said at least one primary vessel and said at least one secondary vessel, and thereby decreasing the amount of ultra-high purity helium gas needed to be withdrawn from said at least one primary vessel and said at least one secondary vessel in order to maintain maximum allowable working pressure of said at least one primary vessel and said at least one secondary vessel.

9. The method of claim 1 further comprising controlling said at least one economizer apparatus to draw ultra-high purity helium gas from said at least one primary vessel and/or said at least one secondary vessel for delivery to said usage site while maintaining ultra-high purity helium liquid in said at least one primary vessel and/or said at least one secondary vessel.

10. The method of claim 1 wherein said at least one primary vessel and said at least one secondary vessel comprise ISO containers.

11. The method of claim 1 wherein said ultra-high purity helium gas is used at said usage site at a use rate of at least about 10 Nm³/hr.

12. The method of claim 1 wherein said usage site is a semiconductor manufacturing site.

13. The method of claim 1 wherein (i) said ultra-high purity helium gas is used as a carrier gas for introducing a precursor into a deposition chamber, (ii) said ultra-high purity helium gas is used for dry etching in LCD processes, (iii) said ultra-high purity helium gas is used in backside cooling to control the rate and uniformity of etching processes of silicon layers, or (iv) said ultra-high purity helium gas is used to check for leaks and line purges.

14. The method of claim 1 further comprising withdrawing ultra-high purity helium liquid from said primary vessel at a temperature not greater than the temperature at which the concentration of at least one impurity in said ultra-high purity helium liquid being withdrawn equals a predetermined limit, wherein the at least one impurity is selected from water, carbon dioxide, oxygen, argon and nitrogen.

15. The method of claim 1 further comprising passing said ultra-high purity helium gas through a low temperature pressure protection (LTPP) unit and a filtration apparatus, prior to delivering said ultra-high purity helium gas to said usage site.

16. A system for delivering ultra-high purity helium gas to a usage site, said system comprising:
at least one primary vessel containing cryogenic ultra-high purity helium fluid, said ultra-high purity helium fluid comprising ultra-high purity helium liquid and gas; said primary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said primary vessel having at least one inlet opening at or near a top portion of the primary vessel through which ultra-high purity helium gas can be fed into the internal vessel compartment; and said primary vessel having at least one outlet opening above a bottom portion of the primary vessel through which said ultra-high purity helium liquid can be dispensed from the internal vessel compartment;
at least one secondary vessel containing cryogenic ultra-high purity helium fluid, said ultra-high purity helium fluid comprising ultra-high purity helium liquid and gas; said secondary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said secondary vessel having at least one outlet opening at or near a top portion of the secondary vessel through which ultra-high purity helium gas can be dispensed to the internal vessel compartment of said primary vessel; said secondary vessel being in ultra-high purity helium gas flow communication with said primary vessel; and said secondary vessel having at least one outlet opening above a bottom portion of the secondary vessel through which said ultra-high purity helium liquid can be dispensed from the internal vessel compartment;
an ultra-high purity helium gas feed line extending exteriorly from at least one outlet opening at or near the top portion of the secondary vessel to the at least one inlet opening at or near the top portion of the primary vessel through which ultra-high purity helium gas can be dispensed to the internal vessel compartment of said primary vessel, the ultra-high purity helium gas feed line containing at least one ultra-high purity helium gas flow control valve therein for control of flow of the ultra-high purity helium gas therethrough, and at least one economizer apparatus; said at least one economizer apparatus comprising a backpressure valve for control of flow of ultra-high purity helium gas therethrough to said usage site;
at least one vaporization apparatus; said vaporization apparatus having at least one inlet opening through which ultra-high purity helium liquid can be fed into the vaporization apparatus; and said vaporization apparatus having at least one outlet opening through which ultra-high purity helium gas can be dispensed from the vaporization apparatus;
an ultra-high purity helium liquid discharge line extending exteriorly from at least one outlet opening above the bottom portion of the primary vessel to the at least one inlet opening of the vaporization apparatus through which ultra-high purity helium liquid can be dispensed to the vaporization apparatus, the ultra-high purity helium liquid feed line containing at least one ultra-high purity helium liquid flow control valve therein for control of flow of the ultra-high purity helium liquid therethrough; and
an ultra-high purity helium gas discharge line extending exteriorly from at least one outlet opening of the vaporization apparatus to said usage site, the ultra-high purity helium gas discharge line containing at least one ultra-high purity helium gas flow control valve therein for control of flow of the ultra-high purity helium gas therethrough.

17. The system of claim 16 wherein said ultra-high purity helium gas discharge line contains a low temperature pressure protection (LTPP) unit and a filtration apparatus.

18. A method for controlling delivery of ultra-high purity helium gas to a usage site, said method comprising:
providing at least one primary vessel containing cryogenic ultra-high purity helium fluid, said ultra-high purity helium fluid comprising ultra-high purity helium liquid and gas; said primary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said primary vessel having at least one inlet opening at or near a top portion of the primary vessel through which ultra-high purity helium gas can be fed into the internal vessel compartment; and said primary vessel having at least one outlet opening above a bottom portion of the primary vessel through which said ultra-high purity helium liquid can be dispensed from the internal vessel compartment;
providing at least one secondary vessel containing cryogenic ultra-high purity helium fluid, said ultra-high purity helium fluid comprising ultra-high purity helium liquid and gas; said secondary vessel comprising one or more wall members configured to form an internal vessel compartment to hold said ultra-high purity helium liquid and gas; said internal vessel compartment having one or more vacuum insulation layers and one or more thermal shield layers aligned adjacent to each other at the periphery of said internal vessel compartment adjacent to said one or more wall members; said secondary vessel having at least one outlet opening at or near a top portion of the secondary vessel through which ultra-high purity helium gas can be dispensed to the internal vessel compartment of said primary vessel; said secondary vessel being in ultra-high purity helium gas flow communication with said primary vessel; and said secondary vessel having at least one outlet opening above a bottom portion of the secondary vessel through which said ultra-high purity helium liquid can be dispensed from the internal vessel compartment;
optionally delivering ultra-high purity helium gas from said primary vessel and/or said secondary vessel through at least one economizer apparatus to said usage site, said at least one economizer apparatus comprising a backpressure valve for control of flow of ultra-high purity helium gas therethrough to said usage site;
admitting to said primary vessel from said secondary vessel ultra-high purity helium fluid, said ultra-high purity helium fluid comprising ultra-high purity helium gas, said ultra-high purity helium gas being admitted to a pressure in said primary vessel sufficient to discharge ultra-high purity helium liquid from said primary vessel;
conveying said ultra-high purity helium liquid from said primary vessel to at least one vaporization apparatus; said vaporization apparatus having at least one inlet opening through which ultra-high purity helium liquid can be fed into the vaporization apparatus; and said vaporization apparatus having at least one outlet opening through which ultra-high purity helium gas can be dispensed from the vaporization apparatus;
effecting a phase change of said ultra-high purity helium liquid in said vaporization apparatus to form ultra-high purity helium gas;
delivering said ultra-high purity helium gas from said vaporization apparatus to said usage site; and
utilizing said ultra-high purity helium gas fed into the internal vessel compartment of said primary vessel from secondary vessel, said one or more thermal shield layers, and/or at least one economizer apparatus to control delivery of said ultra-high purity helium gas to said usage site.

19. The method of claim 18 wherein (i) said ultra-high purity helium gas fed into the internal vessel compartment of said primary vessel from secondary vessel controls delivery rate of said ultra-high purity helium liquid from said at least one primary vessel to said at least one vaporization apparatus and ultra-high purity helium gas from said at least one vaporization apparatus to said usage site and ultra-high purity helium gas from said at least one primary vessel and said at least one secondary vessel through said at least one economizer apparatus to said usage site; (ii) said one or more thermal shield layers control net evaporation rate of said ultra-high purity helium liquid in said at least one primary vessel and said at least one secondary vessel, said net evaporation rate controls delivery rate of said ultra-high purity helium liquid from said at least one primary vessel to said at least one vaporization apparatus and ultra-high purity helium gas from said at least one vaporization apparatus to said usage site, and controls delivery rate of said ultra-high purity helium gas from said at least one primary vessel and said at least one secondary vessel through said at least one economizer apparatus to said usage site; and (iii) said at least one economizer apparatus controls delivery rate of said ultra-high purity helium gas from said at least one primary vessel and said at least one secondary vessel to said usage site while maintaining ultra-high purity helium liquid in said at least one primary vessel and said at least one secondary vessel.

20. The method of claim 18 which comprises at least one of (i) delivering ultra-high purity helium gas from vapor space and/or a thermal shield layer of said primary vessel and/or said secondary vessel through at least one economizer apparatus to said usage site, and (ii) admitting to said primary vessel from vapor space and/or a thermal shield layer of said secondary vessel ultra-high purity helium gas, said ultra-high purity helium gas being admitted to a pressure in said primary vessel sufficient to discharge ultra-high purity helium liquid from said primary vessel.
